(19) United States
(12) Patent Application Publication
(10) Pub. No.: US 2026/0211924 A1
(43) Pub. Date: Jul. 23, 2026

(54) SYSTEMS AND METHODS FOR RESPONDING TO FINANCIAL QUERIES

(71) Applicant: Boeing Employees' Credit Union, Tukwila, WA (US)

(72) Inventors: Manish GARG, Sunnyvale, CA (US); Matthew FITZGERALD, Durham, NC (US); Nadim HOMSANY, Berkeley, CA (US)

(21) Appl. No.: 19/034,482

(22) Filed: Jan. 22, 2025

(51) Int. Cl. G06F 16/335; G06Q 20/10; G06Q 40/00

(52) U.S. Cl. CPC G06F 16/335; G06Q 20/102; G06Q 40/00

(57) ABSTRACT

Methods and systems are provided for processing user queries for financial advice. A user query may be input into a router model that determines appropriate finance agents for processing the query based on agent profiles indicating different financial contexts. The selected finance agents process respective query information to generate responses. An answer model generates an answer to the user query based on the responses from the selected agents.

### BACKGROUND OF THE INVENTION

The present disclosure relates to computer-implemented systems and methods for processing user queries and providing responses. More specifically, the disclosure relates to processing financial queries using machine-learned models and generating responses based on multiple agents.

Conventionally, tailored financial advice is provided by human advisors. Automating provision of such advice would allow more people to access advice, but attempts to provide automated advice have so far been limited. For example, chatbot-style advisors have been used, but have generally been limited to providing general advice, rather than specific, tailored advice. Moreover, automated advisors have been limited due to a need to provide accurate advice, due to the nature of the advice being given

### SUMMARY

In accordance a first aspect of the present disclosure, a computer-implemented method is provided in which a host computer system receives user queries requesting financial advice from a user computer system. The host computer system includes a processor and memory storing instructions that operate a router model, a set of finance agents, and an answer model, each of which may comprise machine learned models. Upon receiving a query, the router model processes it to determine appropriate finance agents for processing the query based on their profiles and financial contexts. The router model selects one or more finance agents from the set of finance agents. For example, the router model may select a first and second finance agent, each associated with different financial contexts and instruction prompts. The selected finance agents process information associated with the user query to generate responses. The first finance agent generates a first response based on a respective instruction prompt. The second finance agent generates a second response based on its instruction prompt. The answer model then generates an answer to the user query based on the responses from the two finance agents.

Thus, techniques of the present disclosure may use a multi-agent approach to generating financial advice. Each agent may comprise a machine-learned model tailored for a particular financial context or task. In a non-limiting example, one agent may be tailored for retirement advice, another agent may be tailored for periodic (e.g. month-to-month) finance accounts. In another example, an agent may be tailored to identify possible financial transactions that can be performed, for example to meet advice generated by another agent. Thus, each individual agent may be suited to a particular task. Individual models may provide more accurate and/or useful responses than using a more broadly capable model. For example, where the agents comprise generative models such as transformer-based generative models, each agent may be configured by a respective instruction or system prompt which directs the model to a narrow focus (e.g., even where the underlying architecture of each model is the same). Using such narrowly focused models may provide more relevant and accurate responses than using a single model for all queries. This may be particularly advantageous for automating financial advice, where achieving a high accuracy and reliability in responses may be important to avoid financially misleading the user. In the present techniques, the routing model automatically selects the most appropriate agents for fulfilling a user request, providing a context-specific configuration of agents for processing the user request. The answer model may determine an ultimate output to the user based on responses from one or more of the selected agents, allowing multiple agents to work in parallel to generate fuller, accurate responses.

In some examples, the host system may determine to access external information related to the user query. In such cases, the host computer system may request information from an external system. The external information may influence the selection of finance agents, generation of agent responses, and/or formulation of the final answer. In a non-limiting example, the host system (e.g., the router model) may seek access to financial accounts associated with the user, either from individual financial institutions or from an account aggregator service. For example, the router model may determine, based on the user query, that the additional context of the user's financial transaction history may be useful for improving the answer to the user query. The host system may therefore automatically identify and seek additional information from external systems, which may be used to automatically tailor selection of the agents to the user's particular circumstances, and/or tailor the generated answer to the user's particular circumstances.

In some examples, before using such external information, the host system may summarize the received external information into summarized external information. This may comprise formatting the external information for input into the routing model, agents, and/or answer model. For example, this may comprise converting the external information to vectors representing the information (e.g., storing information in PostgreSQL form). In some examples, however, the summarization may abstract details from the external information. For example, rather than provide full transaction details to the routing model/agents, a summary of the user's spending may be generated (e.g., by summing spending into spending categories), and providing the categories and summed totals to the models/agents. Such an approach may tailor the external information to the capabilities of the machine-learned model(s). For example, the external information may comprise numerical data, which generative models may not process with the reliability required for financial advice. Providing the summarized information may therefore provide the generative models with summaries that can be reliably processed. In some examples, the summarized external information may be generated by a non-machine-learned model, such as a classical or rules-based algorithm, which may increase accuracy and reliability of the summarized data. Thus, such examples may provide a configuration of models and algorithms which are suited to providing accurate, tailored advice based on numerical data.

In some examples, to access the external information, the host computer may cause the user interface on the user's computer to display a user interface element such as a modal for collecting user credentials. The user interface element may be associated with the external system holding the desired external information. For example, the user interface element may communicate directly with the external system. Thus, the user may securely enter credential information to provide access to the external information within the financial advisor user interface, providing a seamless way for the user to securely provide access to external information. The credential information may be transmitted directly to the external system, without being transmitted to the host system, maintaining data security.

In some examples, the host system may identify potential financial transactions that can be performed. For example, an agent (or plurality of agents) may advise that a particular payment is made (e.g., to pay off a part of a debt), and may identify that the system can automate this payment. For example, an agent or the answer model may identify that the payment is associated with an external partner for whom automated payment is possible. In other examples, the user query may include a request to perform a particular financial transaction. When such opportunities are identified, the answer generated by the answer model may request user permission to compete the financial transaction. Upon receiving user approval, the host computer system may transmit a payment message (e.g., an electronic transfer of funds) to a payee computer system (e.g., to a node at the payee computer system associated with the user). Thus, techniques of the present disclosure may provide an automated system for actioning financial transactions, for example as part of financial advice and/or based on a user query (e.g., provided as text or voice input). Such techniques may thus provide a streamlined system for performing transactions.

According to some techniques of the present disclosure there is provided a computer-implemented method comprising: receiving, at a host computer system, a user query from a user computer system, the user query associated with a financial query; inputting, by the host computer system, the user query into a first model, the first model configured to identify a first agent from a plurality of agents for processing the user query based at least in part on respective profiles of the plurality of agents; providing first information associated with the user query to the first agent; generating, by the first agent, a first response to the user query; and transmitting, to the user computer system, answer information based at least in part on the first response.

According to some techniques of the present disclosure there is provided a system comprising: one or more processors; and memory storing instructions which, when executed by the one or more processors, cause the one or more processors to perform operations comprising: receiving a user query from a user computer system, the user query associated with a request for financial advice from a user; inputting the user query into a router model operated by the system, the router model comprising one or more machine-learned models; determining, by the router model, a first finance agent and a second finance agent of a set of finance agents operated by the system for processing the user query, the set of finance agents comprising one or more machine-learned models, wherein the router model is configured to determine the first finance agent and the second finance agent based at least in part on the user query and on respective profiles of the set of finance agents, wherein a first profile of the set of finance agents indicates a first financial context associated with the first finance agent, and a second profile of the set of finance agents indicates a second financial context associated with the second finance agent; inputting first information associated with the user query into the first finance agent to generate a first response to the user query, wherein the first finance agent is configured based on a first instruction prompt associated with the first financial context; inputting second information associated with the user query into the second finance agent to generate a second response to the user query, wherein the second finance agent is configured based on a second instruction prompt associated with the second financial context; generating, by an answer model operated by the system, an answer to the user query based on the first response and the second response, the answer comprising one or more of: text, a diagram, or audio output; and transmitting the answer to the user computer system.

According to some techniques of the present disclosure there is provided one or more non-transitory computer-readable media storing instructions which, when executed by a computer, cause the computer to perform operations comprising: one or more processors; and memory storing instructions which, when executed by the one or more processors, cause the one or more processors to perform operations comprising: receiving a user query from a user computer system, the user query associated with a request for financial advice from a user; inputting the user query into a router model operated by the system, the router model comprising one or more machine-learned models; determining, by the router model, a first finance agent and a second finance agent of a set of finance agents operated by the system for processing the user query, the set of finance agents comprising one or more machine-learned models, wherein the router model is configured to determine the first finance agent and the second finance agent based at least in part on the user query and on respective profiles of the set of finance agents, wherein a first profile of the set of finance agents indicates a first financial context associated with the first finance agent, and a second profile of the set of finance agents indicates a second financial context associated with the second finance agent; inputting first information associated with the user query into the first finance agent to generate a first response to the user query, wherein the first finance agent is configured based on a first instruction prompt associated with the first financial context; inputting second information associated with the user query into the second finance agent to generate a second response to the user query, wherein the second finance agent is configured based on a second instruction prompt associated with the second financial context; generating, by an answer model operated by the system, an answer to the user query based on the first response and the second response, the answer comprising one or more of: text, a diagram, or audio output; and transmitting the answer to the user computer system.

Although generally described herein as relating to providing financial advice, in some examples the methods and systems may be used to respond to any user queries, for example user queries seeking any kind of advice. The models and agents may be configured for such a different application, for example each agent may be configured to provide advice in a particular sub-domain of a general advice domain the system is designed for.

### BRIEF DESCRIPTION OF THE DRAWINGS

Examples of the present disclosure will now be described with reference to the accompanying drawings:

FIG. 1 is a schematic diagram showing a host computer system in communication with a user computer system and an external system.

FIG. 2 is a schematic diagram showing a user interface for requesting access to an external system.

FIG. 3 is a schematic diagram illustrating automated performance of a financial transaction by the host computer system.

FIG. 4 is a flow diagram showing operations for processing user queries according to techniques of the present disclosure;

FIG. 5 is a flow diagram showing operations for retrieving and processing external information according to techniques of the present disclosure;

FIG. 6 is a flow diagram showing operations for processing financial transactions according to techniques of the present disclosure; and FIG. 7 is a flow diagram showing operations for processing user queries according to techniques of the present disclosure.

### DETAILED DESCRIPTION OF CERTAIN INVENTIVE EMBODIMENTS

### Example Architecture

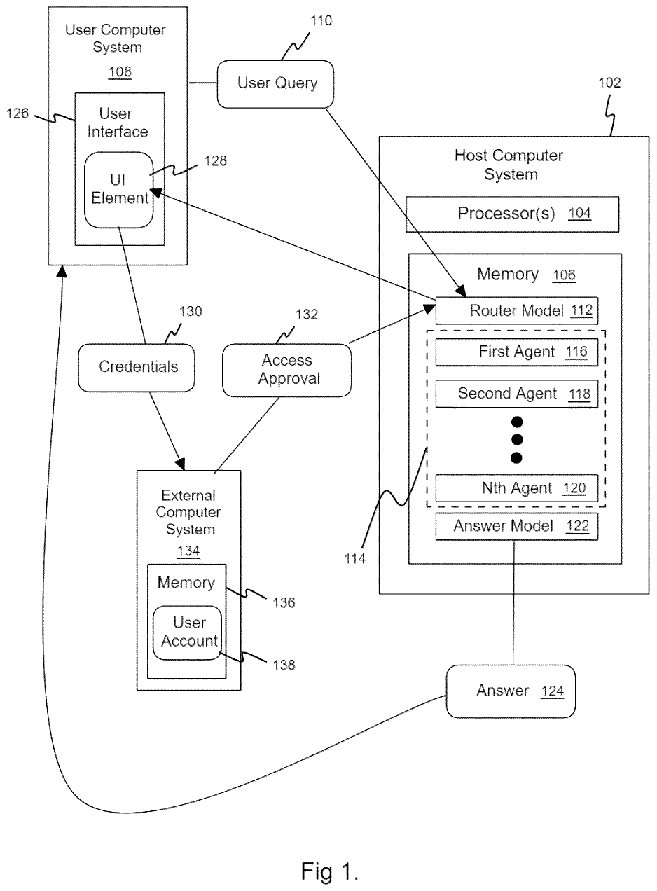

FIG. 1 illustrates a schematic diagram showing a host computer system 102 in communication with a user computer system 108 and an external computer system 134. The host computer system 102 includes a processor 104 and memory 106. The processor 104 can be implemented as one or more microprocessors, microcomputers, microcontrollers, digital signal processors, central processing units, state machines, logic circuitries, and/or any devices that manipulate signals based on operational instructions. The memory 106 can include one or more computer-readable storage media, such as RAM, ROM, EEPROM, flash memory, or other suitable memory devices. The memory 106 may store instructions which, when executed, cause the processor(s) 104 to execute and/or operate various models and agents, as described below. In some examples, such models and agents may execute exclusively on the host computer system 102. In other examples, the models and/or agents may execute at least partially on an external system, such as an external server associated with a different party to the host computer system 102. In such cases, the host computer system 102 may be said to operate the models/agents in that the host computer system 102 causes processing on the external server to occur.

The user computer system 108 may be implemented as a computer, smartphone, tablet computer, or other computing device comprising (or coupled to) a display for presenting a user interface 126. The user interface may for example be presented as a web page in an internet browser, or in a dedicated program or app executing on the user computer system 108. The user interface may present as a chatbot interface.

The external computer system 134, discussed further below, may be implemented as one or more server computers or other computing devices, and may store information such as financial records, account information, credit reference information, or other data associated with users.

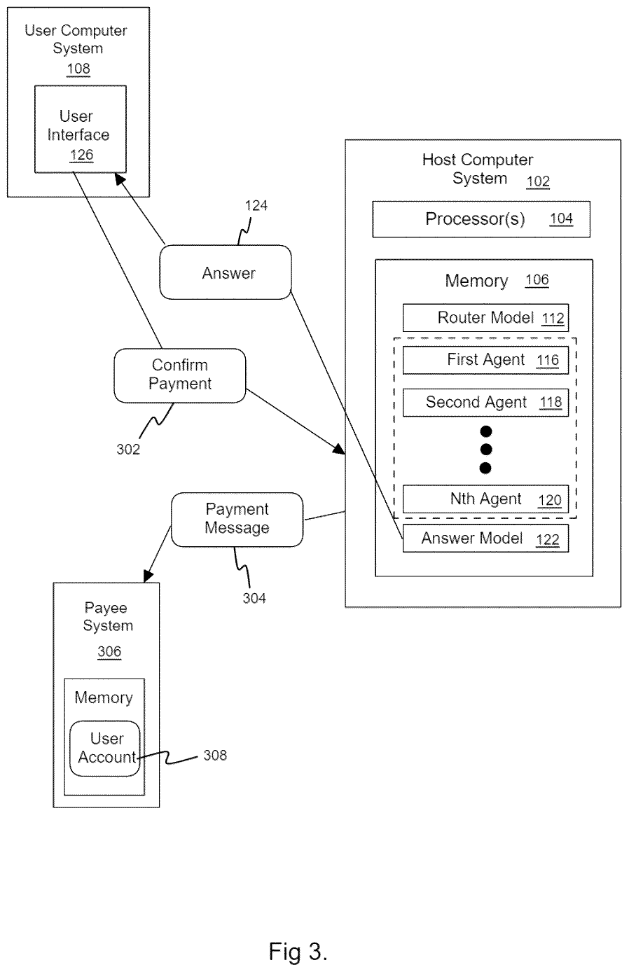

A user of the user computer system 108 may provide a user query 110, for example by entering the user query 110 into a user interface 126 displayed on the user computer system 108. The user query 110 may request financial advice, such as guidance on retirement savings, house purchase planning, or monthly finance management. Alternatively or additionally, as discussed further in relation to FIG. 3 below, the user query 110 may include a request to perform a financial transaction, such as making a payment. The user query 110 may be provided by the user as text, or may be provided as voice input. In the latter case, the voice input may be processed by the user computer system 108 or by the host computer system 102 to generate text data based on the voice input. The user query 110 may be transmitted from the user computer system 108 to the host computer system 102, for example via a network such as the internet. The user query 110 may be transmitted as a text string, or may undergo processing prior to transmission, for example to generate one or more vectors representing the information provided by the user.

Upon receipt at the host computer system 102, the user query 110 may undergo validation, for example based on format rules and/or content rules stored at the host computer system 102. For example, validation may verify proper formatting of the user query 110 for subsequent processing. Alternatively or additionally, validation may and confirm it the user query 110 relates to allowed content. For example, it may be verified that the user query 110 is a request associated with an allowable context or topic. For example, it may be verified that the user query 110 is a request for financial advice, rather than a query relating to any other context. Such an approach may reduce the possibility that the host computer system 102 can be ‘tricked’ into providing advice unrelated to the specific financial contexts it has been designed for. As discussed below, an answer 124 generated by the answer model 122 may be similarly validated, for example based on format and/or context rules.

The host computer system 102 operates a router model 112. The router model 112 may be or comprise a generative machine-learned model, such as a transformer-based generative model (e.g., a GPT model). The router model 112 may be configured to select one or more finance agents from a set 114 of finance agents based on the user query 110. The set 114 may include any number of finance agents, for example including a first finance agent 116, second finance agent 118, and so on up to an nth finance agent 120. Each finance agent 116, 118, 120 may be pre-configured for a particular financial context or task. For example, the first agent 116 may be configured to provide retirement advice, while the second agent may be configured to provide monthly finance advice. One agent 116, 118, 120 may be a general answer agent, for example configured to generate responses based on no or minimal context about the user (e.g., based primarily on the augmented data, discussed below). Such an agent may be used for example where the user has not logged in, so information about the user is not known.

Each finance agent 116, 118, 120 may comprise a machine-learned model, such as a generative model. A plurality of finance agents 116, 118, 120 may share the same architecture. For example, the plurality of finance agents 116, 118, 120 may all be instances of the same generative model. However, each finance agent 116, 118, 120 may be configured based on a respective instruction prompt (e.g., which may be provided to the underlying generative model as part of a model query with other information associated with the user query 110 in order to generate a response). Each respective instruction prompt may relate to a specific financial context for that agent 116, 118, 120. As a non-limiting example, an instruction prompt may specify that the first agent 116 is for providing retirement advice based on age profiles of a user, and is to use known retirement planning techniques to generate a specific plan for a user. In general, the more specific the instruction prompt, the more tailored and accurate the responses may be. The specialized instruction prompts may allow each finance agent 116, 118, 120 to process queries within defined financial domains. Finance agents 116, 118, 120 can analyze queries through specific financial lenses, such as investment planning, tax considerations, or retirement strategies. This context-aware processing may help produce targeted and domain-specific responses, increasing accuracy and reliability of the responses.

The router model 112 may evaluate the user query 110 against profiles associated with each finance agent 116, 118, 120 in the set 114 to determine which agents 116, 118, 120 are most suitable for processing the query. In an example, the router model 112 may selected the first agent 116 and the second agent 118 for a particular user query 110. In other examples, the router model 112 may select only one agent 116, 118, 120; or may select any multiple number of agents 116, 118, 120. The router model 112 may be configured, for example by an instruction prompt, based on profiles associated with the agents 116, 118, 120 in the set. For example, the first agent 116 may be associated with a first profile indicating the first financial context for which the first agent 116 has been configured (e.g., via its own instruction prompt). In some examples, the first profile may be the respective instruction prompt used to configure the first agent 116. Similar profiles may be provided for the rest of the set 114. The router model 112 may use the context provided by these profiles to determine which agents 116, 118, 120 are suitable for responding to the user query 110. Thus, the router model 112 may dynamically configure the host computer system 102 for a particular user query 110. The router model 112 may interact with (e.g., initiate) one or more components or applications, whether locally hosted or otherwise, such as one or more tools configured for particular operations. Such components may be non-machine learned components. Such components may be used, for example, to request and or retrieve additional information associated with the user query 110, such as discussed further below in relation to external information. The finance agents 116, 118, 120 and/or answer model 122 discussed below may similarly use such components.

Once the finance agent(s) 116, 118, 120 have been selected, information associated with the user query 110 is provided to the selected agents 116, 118, 120. In the example where the first agent 116 and second agent 118 are selected, information may be provided to the first agent 116 and second agent 118 to be used as an input to their respective models (e.g., as (part of) a query to their underlying generative model). The provided information may be the user query 110 itself. Alternatively, information derived from the user query 110 may be provided to the agent(s) 116, 118. For example, the user query 110 may be pre-processed into a format suitable for the agent(s) 116, 118, for example comprising a vector representation of the user query 110. In some examples, different information may be provided to different selected agents 116, 118. For example, information relevant to the context of a particular agent 116, 118 may be extracted from the user query 110 and provided to that agent 116, 118, while less relevant information to that agent 116, 118 may be omitted.

The selected agents 116, 118 (or a subset thereof, e.g., when one agent 116, 118 fails or determines that a response cannot be generated) may generate a respective response to the information it is provided. The selected agents 116, 118 may operate in parallel. That is, each selected agent 116, 118 may concurrently process the information provided to it, independently of the operations on other agents 116, 118. In other examples, one or more agents 116, 118 may be operated in series, for example providing the output of one agent 116 as part of the input to another agent 118. The use of multiple finance agents 116, 118, for example working in parallel, may enable comprehensive analysis of financial queries. Each agent can process different aspects of the query simultaneously based on their specialized financial contexts. This parallel processing approach may provide different financial perspectives and expertise to develop thorough responses to user queries 110.

In some examples, one or more agents 116, 118, 120 may be configured to generate responses based at least in part on augmented or background data. For example, the augmented data may be associated with a respective agent's financial context. Thus, for example a retirement agent may generate responses based on data associated with known retirement planning techniques. The augmented data may be or comprise publications, text books, articles, etc., providing specialized background knowledge relating to finance, or that agent's specific context in particular. For example, where an agent comprises a generative model, the augmented information may be retrieved and applied as part of a retrieval-augmented generation (RAG) process. Such an approach may guide the responses generated by an agent 116, 118, 120, allowing control of the responses that can be generated while still allowing the flexibility of using a pre-trained general generative model. In some examples, the host computer system 102 may be operated by multiple different parties. For example, the host computer system 102 may be controlled by a service provider, but may run instances of the techniques discussed herein for each of multiple external organizations. In such cases, the host computer system 102 may be designed to maintain data separation between data associated with different partners. For example, the augmented data, or part thereof, may be associated with a particular partner organization, and may not be usable in generating responses processed through operations of a different partner organization.

The responses generated by the selected agents 116, 118 may be provided to the answer model 122. The answer model 122 may comprise a machine-learned model, such as a generative model, e.g. a transformer-based generative model. The answer model 122 may be an instance of the same underlying model as the router model 112 and one or more of the finance agents 116, 118, 120, but may be configured for its particular role based on an instruction prompt. The answer model 122 may receive the various response generated by the selected agents 116, 118, and may determine an answer 124 to be provided back to the user computer system 108. For example, the answer model 122 may one (or a subset) of the generated responses for the answer 124, for example based on comparing responses and identifying the response(s) best suited to the user query. In some cases, the answer model 122 may combine multiple responses to generate the answer 124. For example, the answer model 122 may be or comprise an aggregator component configured to combine multiple responses. By combining responses from multiple finance agents 116, 118, the answer model 122 may produce comprehensive answers that incorporate different financial perspectives, and/or which are tailored to the specific user query 110. In some examples, an answer 124, or part thereof, generated by the answer model 122 may be validated prior to transmission to the user computer system 108. This validation may be performed by the answer model 122 itself, or by any other component of the host computer system 102. Validation may be based on format and/or content of the generated answer 124. For example, validation may confirm that the answer 124 relates to an allowed context or topic, for example validating that the answer 124 relates to financial advice or another predetermined topic. For example, validation may verify that the answer 124 relates to topics associated with the agents 116, 118 used in generating the answer 124. Such validation may be considered a ‘sense-check’, ensuring that the host computer system 102 outputs answers 124 within constrained topics.

The answer 124 may be in any form, for example including one or more of text, diagrams, or audio output. In some examples, one or more of the finance agents 116, 118, 120, and/or the answer model 122 itself may be configured to determine optimal output forms data. For example a finance agent 116, 118, 120 may be configured to determine if a graph or chart is appropriate for displaying data. This answer 124 is transmitted back to the user computer system 108 for presentation to the user through the user interface 126. The answer 124 may be presented visually, or may be provided as audio feedback, for example using a text-to-voice process to convert generated text answers into an artificial voice response (which may be hosted either on the host computer system 102 or on the user computer system 108).

### Gathering Additional Information

In some examples, the host computer system 102 or an element thereof may determine that additional information may improve the generated answer 124. In such circumstances, the host computer system 102 may seek the desired additional information, for example from the user, from information about the user stored on the host computer system 102, and/or from one or more external computer systems. For example, demographic information such as age may be useful in tailoring advice (e.g., retirement advice may vary depending on whether the user is far from typical retirement age, near typical retirement age, or has retired). The host computer system 102 may request such information directly from the user, via the user interface 126. Alternatively, the host computer system 102 may already have access to such information. For example, the memory 106 may store information associated with the user which can be accessed. The host computer system 102 may request that the user login or may otherwise identify the user before or after receiving the user query 110, which may allow existing information associated with the user to be retrieved.

Any additional information retrieved from any source may be provided as input to the router model 112, the selected agents 116, 118, and/or the answer model 122. For example, the router model 112 may request and receive additional information, which then may be provided as additional input context for selecting from among the set 114 of finance agents. In this way, the selection of agents 116, 118 itself may be tailored based on additional information associated with the user. Alternatively or additionally, the additional information may be provided to one or more of the selected agents 116, 118 to be used as additional input from which the respective responses generated by the selected agents 116, 118 are generated. Such an approach may further tailor the responses to the specific circumstances of the user, providing more relevant advice. Still further alternatively or additionally, the additional information may be provided to the answer model 122 to formulate the answer 124. In some examples, the answer model 122 may be configured to determine when additional information would improve generated responses, and may seek or request additional information, for example as part of the answer 124. Such additional information may be provided to the router model 112 and/or selected agents 116, 118 to re-generate responses and thus provide an updated answer 124.

A particular example of additional information may be external information, i.e., information associated with the user held on an external computer system 134. The external computer system 134 may contain information associated with the user or a user account 138. For example, the external computer system 134 may be operated by or otherwise associated with an external financial institution such as a bank with which the user has an account. Alternatively the external computer system 134 may be associated with a third party service, such as a financial data aggregator (e.g., a service holding information about multiple accounts at different institutions held by the user).

FIG. 1 illustrates an example of how external information may be requested and received by the host computer system 102 for use in tailoring the answer 124 to the user. The external information may for example comprise or otherwise be associated with financial transactions, such as bank account transactions, credit card transactions, etc. The external information may comprise or otherwise be associated with credit rating information (e.g., credit score, payment history, debt amounts, etc.). The external information may be requested by and/or provided to any of the router model 112, selected agents 116, 118, and/or answer model 122, as discussed above for general additional information.

In the illustrated example, upon determining to request external information, the host computer system 102 may cause a user interface element 128 to be displayed in the user interface 126 on the user computer system 108. The user interface element 128 may be a modal (or modal window), or other gateway element associated with the external computer system 134. The user interface element 128 may receive credential information 130 from the user, and provide the credential information 130 directly to the external computer system 134 (rather than transmitting such information to the host computer system 102). If the credential information 130 is verified, the external computer system 134 may transmit access approval 132 (e.g., an access token) to the host computer system 102, for example directed to an application program interface (API) of the host computer system 102. The host computer system 102 may use the access approval 132 to access the desired external information directly from the external computer system 134. The access approval 132 may allow one-time access, or may allow repeated access, for example allowing the host computer system 102 to update locally stored information associated with the user for subsequent use and/or to retrieve information when appropriate for a subsequent query from the same user. Such a modal-based system may allow the user to seamlessly and securely authorize access to external information from within the same user interface 126 as used to request and receive financial advice, providing a more efficient interface for the user.

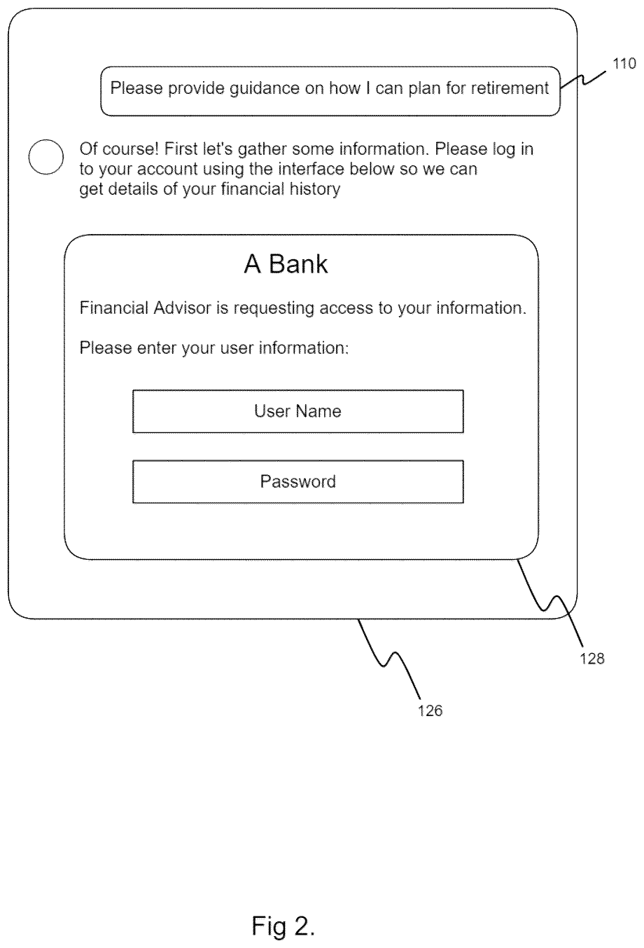

FIG. 2 illustrates a schematic diagram showing an example implementation of a user interface 126 presented on the user computer system 108. As discussed above, the user interface 126 can be configured to receive a user query 110 requesting financial guidance or advice. In this example, the user interface 126 includes a user interface element 128 that facilitates interaction with external systems such as external computer system 134. The user interface element 128 can be displayed when the host computer system 102 (or a component thereof) determines that access to external information would help in processing the user query 110. In the illustrated example, the user interface element 128 is implemented as a modal window, overlay, or dedicated section within the user interface 126. When displayed, the user interface element 128 provides input fields or other interactive components through which users can securely provide credential information for accessing their account or information on the external computer system 134. In this example, the modal links to a single bank, “A Bank”, but in other examples the modal may be associated with third party aggregator services. As illustrated, the user interface element 128 may be presented with a response from the host computer system 102, for example explaining the need for the credential information.

As will be appreciated, any other technique for obtaining user consent and credentials to access external information may be used. For example, a redirect flow may be used to direct the user to an authentication page associated with the external computer system 134; or the user interface element 128 may be a general (e.g. modeless) element configured to perform an API call to communicate with the API on the external computer system 134. In general any known authentication protocols may be used to verify the user and provide the host computer system 102 with access, for example including OAuth protocols and/or open banking protocol. In other examples, the host computer system 102 may request that the user directly provide additional information, for example by uploading a document via the user interface 126. The host computer system 102 or model thereof may communicate with a component or tool configured to access external information, for example by initiating, inputting information into, and/or otherwise configuring and/or controlling said component or tool). The techniques discussed herein for automatically determining to seek additional information to provide additional context for responding to user queries, and for receiving such information from external systems, may allow the financial advisor system and methods to interact with a large range of different external institutions. Thus, information on a user may be gathered from a number of different sources (e.g., by requesting data as above from each of a number of respective external computer systems 134). The answer 124 can therefore be far more tailored to a fuller context of the individual user's circumstances than would be possible if the host computer system 102 only had access to records held by a single institution or organization (e.g., the institution operating the host computer system 102).

Additional information, such as external information, may be provided to the host computer system 102 in a form that is not well-suited to the router model 112, set 114 of agents, and/or the answer model 122. For example, the additional information may comprise numerical information, such as lists of transactions. Generative models, which may be used for the models/agents in host computer system 102, may not be as reliable at processing and interpreting large amounts of numerical data as they are at other tasks . Thus, in some examples the additional information may be pre-processed by the host computer system 102 into summarized data. For example, the pre-processing may comprise performing numerical or statistical analysis on the additional information to generate a summarized version of numerical data it contains, and/or to categorize aspects of the additional information. For example, lists of transactions may be summarized by categorizing transactions, and summing the total amount of transactions in each category, for example per time period such as monthly. As another example, the additional information may comprise credit reference information such as payment history. The pre-processing may provide statistical analysis of the payment history, such as total number of payments made on time, total number of payments missed, percentage of payments made on time, age of debt, total debt remaining, etc. Further, the additional information may comprise a credit score. The pre-processing may assign a category to the credit score, for example a category indicating that the credit score is poor, good, excellent, etc. Such summarized information may thus be in a more qualitative form, highlighting key information which can be used by the generative models to provide accurate, tailored advice. In some examples, the pre-processing may be performed by non-machine-learned models, such as classical, rule-based algorithms. Such algorithms may reliably and deterministically generate the summarizations of data, ensuring good quality data is input into the models/agents, and thus helping to ensure that the host computer system 102 reliably generates useful, accurate advice based on the user query 110.

### Automated Financial Transactions

FIG. 3 illustrates additional features that can be implemented by the host computer system 102 described in FIG. 1, relating for example to automated payment processing capabilities. The schematic diagram of FIG. 3 shows interactions between the host computer system 102, the user computer system 108, and a payee computer system 306. The payee computer system 306 may be a computer system operated by or otherwise associated with a financial institution, such as a bank or financial provider. The payee computer system 306 may be an external computer system, such as external computer system 134. Indeed, in some examples, the payee computer system 306 may be the same as the (or one of the) external computer systems 134 from which external information is retrieved as described above.

When processing a user query 110, the answer model 122 may generate an answer 124 that includes a request for user permission to process an identified financial transaction. For example, one of the selected agents 116, 118 may be configured to identify financial transactions, such as payments, that the user could make, for example based on context provided in external information such as debt information. The same or a different agent 116, 118, or the answer model 122, may be configured to determine whether the host computer system 102 is able to automatically initiate the finance transaction on behalf of the user. For example, it may be determined that the financial transaction is with a financial institution or service provider which has an agreement with the operator of the host computer system 102, or for which the host computer system 102 otherwise has the means to initiate transactions for (e.g., to push payment to a bank account). Where the components of the host computer system 102 both determine to recommend performing a financial transaction (e.g., paying towards a debt), and that the host computer system 102 has the ability to process such a financial transaction, the answer 124 generated by the answer model 122 may indicate this and seek user approval to proceed. This answer 124 may presented to the user through the user interface 126 on the user computer system 108. The user interface 126 may enable the user to review the proposed transaction(s) and provide authorization.

If the user indicates, for example via the user interface 126, that the financial transaction should proceed, a confirmation message (i.e. user permission indication) 302 may be sent back to the host computer system 102 from user computer system 108. After receiving the confirmation message 302, the host computer system 102 may process the financial transaction. For example, the host computer system 102 may immediately (or near-immediately) process the financial transaction. Alternatively, the host computer system 102 may schedule the transaction for a later time. In some examples, as illustrated in FIG. 3, when it is determined to proceed with a transaction, the host computer system 102 may generate a payment message 304. For example, the payment message 304 may contain transaction details, such as funds for a payment, and may be formatted according to requirements of the intended recipient system. The host computer system 102 may transmit the payment message 304 to a user account 308 or node associated with the user of the payee system 306. For example, the node may be a unique virtual bank account associated with the user, and/or associated with the financial transaction (e.g., a debt account). The funds may be already held in association with the host computer system 102. For example, funds may have been pre-collected from the user by an organization operating the host computer system 102 and may for example be held in a unique virtual bank account associated with that user for later payment of funds. Alternatively, the host computer system 102 may send further messages to the user computer system 108 requesting payment of funds, or access to a source of funds (e.g., a bank account of the user, or debit or credit card information). Sending the payment message 304 may thus, in at least some examples, cause funds to be transferred to the payee. Any such operations for providing the financial transaction may be performed by a component or tool associated with the host computer system 102 (e.g., locally hosted, or on a remote system with which the host computer system 102 can communicate). For example, the answer model 122 or other model of the host computer system 102 may communicate with a payment tool (e.g., including initiating, inputting data into, and/or otherwise configuring and/or controlling the payment tool) to provide the financial transaction.

In some examples, the host computer system 102 may recommend and process recurring financial transactions, such as regular payments to a debt account. In such examples, the host computer system may, after approval from the user, schedule recurring payments. For example, the host computer system 102 may use information gather from the user during the advice conversation to automatically open a user account on a recurring payment system associated with the host computer system 102 (e.g., an automated debt paydown system).

Financial transactions may be processed by any technique. For example, the host computer system 102 may perform, or cause to be performed, the operations discussed in US 2003033245 A1, “METHOD FOR COLLECTION OF AMOUNTS OVERDUE AND DUE BY PAYDAY-TO-PAYDAY DRAFTS”, and/or U.S. Pat. No. 7,225,154 B2, “METHODS AND SYSTEMS FOR COORDINATING POOLED FINANCIAL TRANSACTIONS”, each of which is incorporated herein by reference in its entirety for all purposes.

Thus, techniques of the present disclosure may provide automated payments seamlessly from within the same financial advisor user interface 126. This may avoid the need, for example, for the user to open a different program on their device to manually arrange a payment, providing for much more efficient interaction with their user computer system 108. Furthermore, the user query 110 may explicitly request that a financial transaction is performed. Thus, the user may use text or voice input to initiate a payment via the host computer system 102, without having to manually set up a payment, for example in a separate app on their device associated with an individual financial institution. Moreover, the host computer system 102 may be able to make payments to multiple different payee systems 306, for example each operated by different financial institutions, providing much greater flexibility in processing financial transactions for the user.

### Example Methods

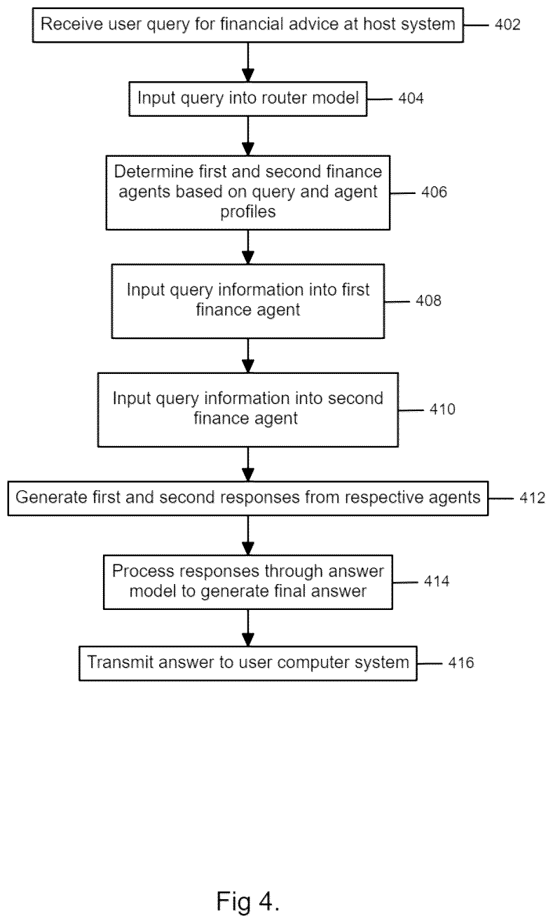

FIG. 4 illustrates a flow diagram showing example operations according to techniques of the present disclosure. For example, these operations may be performed by the host computer system 102 of FIG. 1. The operations may enable processing of financial queries to generate responses using multiple finance agents.

At block 402, a user query requesting financial advice is received at the host computer system. The query may be transmitted from a user computer system and can include requests for various types of financial guidance.

The received query is input into a router model at block 404.

At block 406, first and second finance agents are selected by the router model from set of finance agents. The first and second finance agents are selected based both the user query, and on profile associated with the agents of the set of finance agents. For example, the router model may evaluate the user query content against profiles associated with each finance agent to identify agents with relevant expertise for processing different aspects of the query.

Query information (e.g., the user query itself or information derived therefrom) is input into the first finance agent at block 408. The first finance agent is configured based on a first instruction prompt. For example, the first instruction prompt may be appended to the query information and input into the model underlying the first finance agent. The first instruction prompt for example provides context-specific guidance to the first finance agent regarding how to process the query information within its designated financial domain.

At block 410, the (or different) query information is similarly input into the second finance agent. The second finance agent is configured (e.g., provided with as an input) a second instruction prompt. The second instruction prompt for example directs the second finance agent to process the query information according to its distinct financial context.

First and second responses are generated from the respective finance agents at block 412. Each finance agent may process the query information according to its specific instruction prompt and financial context to produce a response incorporating its specialized expertise.

At block 414, the responses from both finance agents are processed through an answer model to generate a final answer. The answer model for example integrates the different perspectives and analyses provided by each finance agent into a comprehensive response.

The final answer is transmitted to the user computer system at block 416. This answer can include various formats such as text, diagrams, or audio output to effectively communicate the financial guidance to the user.

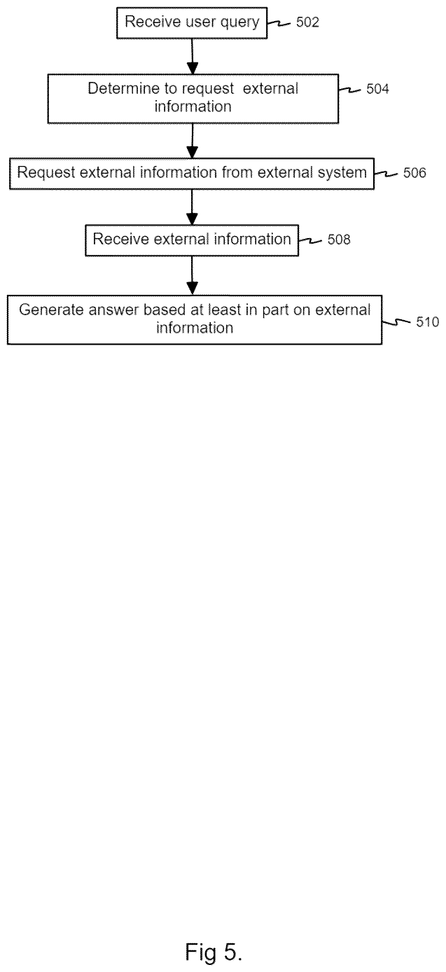

FIG. 5 illustrates operations that can be performed in conjunction with the operations of FIG. 4, for example by one or more components of the host computer system 102 described in FIG. 1. The operations of FIG. 5 may enable retrieval and processing of external information to enhance responses to user queries.

When a user query is received 502 (which may be same as operation 402), the host computer system 102 may determine whether external information should be accessed at block 504. This determination may be made for example by the router model, first finance agent, second finance agent, or answer model, for example based on analysis of the user query content. For example, if a query requests advice about retirement savings, the system may determine that accessing the user's current account balances and/or regular spending would be beneficial.

Upon determining that external information is desired, the host computer system 102 sends a request at block 506 to an external system. The request can include authenticated credentials previously provided by the user, for example through the user interface element. Alternatively the request may include previously granted permission, such as an access token, provided to the host computer system based on authentication by the user, e.g., in a modal as discussed above. The external system may processes the request and return the requested information, which is received at block 508 by the host computer system.

The received external information may be used to generate, at block 510, the answer to the user query. The external information may be utilized in multiple ways. For example, the router model may use the external information to select appropriate finance agents from the set of finance agents. As a non-limiting example, if the external information indicates significant investment holdings, the router model may select finance agents with tailored to advice on investment management. As another option, the first finance agent and/or second finance agent may generate their respective responses based at least in part on the external information. For example, the external information (or summarized external information), or part thereof, may be provided as further inputs to the agents. Further, the answer model may be provided with the external information as an input when generating the final answer.

The external information may for example include financial records, account balances, transaction histories, or other user-specific data stored in external systems. Access to this information may allow the system to provide personalized financial guidance based on actual user circumstances rather than general assumptions. For example, when generating retirement planning advice, the system can consider current savings levels, investment allocations, and contribution patterns from external account data.

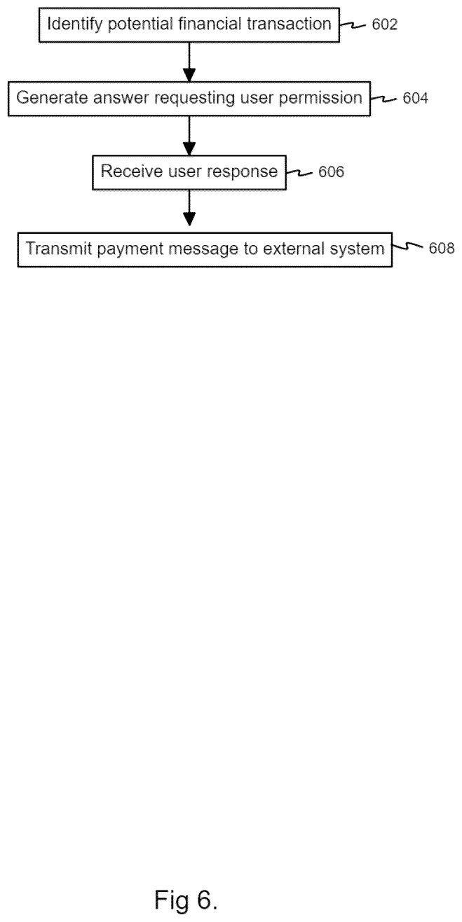

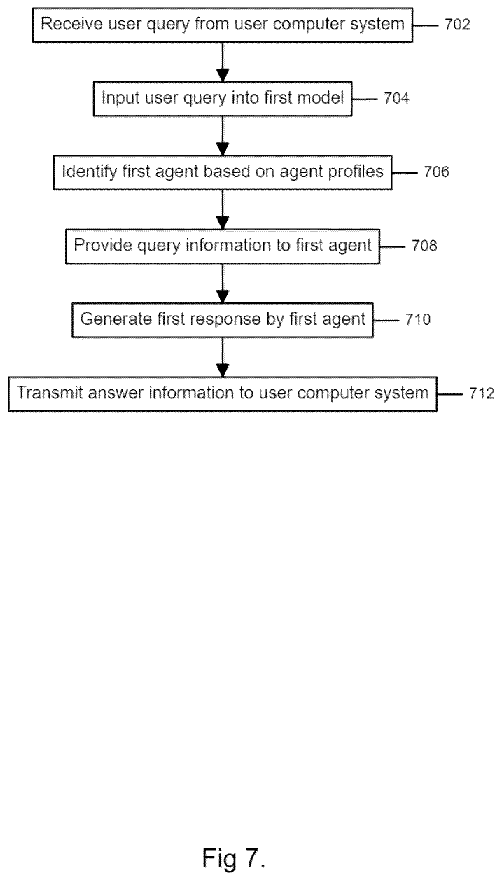

FIG. 6 illustrates a further operations that can be implemented in conjunction with the operations of FIGS. 4 and/or 5. The operations of FIG. 6 may provide automated transaction handling capabilities that integrate with the system's financial advisory functions.

At block 602, the host computer system (or any component thereof) may identify a potential financial transaction that the user could make. This identification can be performed by one or more of the first finance agent, second finance agent, or the answer model. The financial transaction may be identified based on analysis of user queries, financial context, or other relevant information available to the system.

Following identification of the potential transaction, at block 604, the answer model 122 may generate an answer requesting user permission to process the identified financial transaction. The answer may include details about the proposed transaction and may be presented to the user through the user interface of the user computer system.

At block 606, the host computer system 102 may receive a user response through the user computer system 108. The response may indicate whether the user authorizes proceeding with the proposed financial transaction. The user interface may enable users to review the transaction details and provide their authorization decision.

After receiving user authorization, at block 608, the host computer system may transmit a payment message to a node of an external computer system associated with the user (e.g., a node representing a user's account). The payment message may cause transfer of funds to the external computer system.

Such a method may enable direct execution of financial transactions identified through the system's advisory capabilities. By automating the transaction identification and processing sequence, users can move seamlessly from receiving financial guidance to executing recommended transactions through a single integrated system. The system can proactively detect opportunities for financial transactions without requiring manual identification by users. The integration of transaction identification with financial advisory functions may create a more responsive and anticipatory financial management experience.

The transaction processing framework may interface with various external computer systems and payment networks. This multi-system compatibility may enable execution of diverse transaction types through different payment channels and financial institutions. The broad connectivity supports implementation of automated financial actions while maintaining consistent user control mechanisms.

Users can initiate and authorize transactions through natural language interactions using text or voice inputs. This conversational interface may remove traditional friction in payment setup by automatically interpreting user intent and configuring appropriate transaction parameters. The system may handle the technical complexity of payment processing while presenting an intuitive interaction model.

FIG. 7 illustrates an example computer-implemented method according to techniques of the present disclosure.

At block 702, a host computer system receives a user query from a user computer system. The user query may relate to a financial query.

At block 704, the host computer system inputs the received user query into a first model. At block 706 the first model processes the user query to determine which agent from a plurality of available agents should handle the query. The first model may analyze the query content and compare it against respective profiles of the plurality of agents. Each agent profile may contain information about the agent's capabilities, expertise areas, and historical performance in handling different types of queries.

Once the first agent is identified, the host computer system provides first information associated with the user query to the first agent at block 708. This first information can include the original query, relevant context, user information, or other data needed for processing the query.

At block 710, the first agent generates a first response to the user query. The first agent processes the provided information and may formulate an appropriate response based on its specialized capabilities and the query requirements. The response generation may involve accessing databases, applying specialized algorithms, or utilizing other computational resources available to the agent.

Finally, at block 712, the host computer system transmits answer information to the user computer system. This answer information is based at least in part on the first response generated by the first agent.

The methods discussed herein can be implemented using various computing systems, including servers, cloud computing resources, or distributed computing networks. The communication the various computer systems may occur through any of various network protocols and interfaces, for example via the internet. The methods discussed herein may be implemented as instructions stored on computer-readable media which, when executed by a computer, cause the computer to perform the method.

The following clauses provided further statements of techniques according to the present disclosure:
1. A computer-implemented method comprising: receiving, at a host computer system, a user query from a user computer system, (e.g., associated with a request for financial advice or other advice) from a user, wherein the host computer system comprises a processor and memory storing instructions which, when executed by the processor, operate a router model, a set of agents, and an answer model, each of the router model, the set of agents, and the answer model comprising one or more machine learned models; inputting, by the host computer system, the user query into the router model; determining, by the router model and based at least in part on the user query and on respective profiles of the set of agents, a first agent and a second agent for processing the user query, wherein a first profile of the set of agents indicates a first context associated with the first agent, and a second profile of the set of agents indicates a second context associated with the second agent; inputting, by the host computer system, first information associated with the user query into the first agent to generate a first response to the user query, wherein the first agent is configured based on a first instruction prompt associated with the first context; inputting, by the host computer system, second information associated with the user query into the second agent to generate a second response to the user query, wherein the second agent is configured based on a second instruction prompt associated with the second context; generating, by the answer model and based on the first response and the second response, an answer to the user query, the answer comprising one or more of: text, a diagram, or audio output; and transmitting, by the host computer system, the answer to the user computer system.
2. The computer-implemented method of clause 1, comprising: determining, based at least in part on the user query and by one or more of the router model, the first agent, the second agent, or the answer model, to access external information associated with the user; requesting, by the host computer system, the external information from an external system; receiving the external information from the external system; and one or more of: determining the first agent and the second agent based at least in part on the external information; generating the first response and the second response based at least in part on the external information; or generating the answer to the user query based at least in part on the external information.
3. The computer-implemented method of clause 2, comprising: generating, by the host computer system, summarized external information from the external information; and one or more of: determining the first agent and the second agent based at least in part on the summarized external information; generating the first response and the second response based at least in part on the summarized external information; or generating the answer to the user query based at least in part on the summarized external information.
4. The computer-implemented method of clause 3, comprising generating the summarized external information by a non-machine-learned algorithm.
5. The computer-implemented method of any of clauses 2 to 4, wherein the user query is received in a user interface presented on the user computer system, and wherein the method comprises: causing, by the host computer system, a user interface element to be displayed in the user interface, the user interface element associated with the external system and configured to receive credential information from the user for accessing the external information; and receiving, by the host computer system, the external information based on verification of the credential information by the external system.
6. The computer-implemented method of any of clauses 2 to 5, wherein the external information comprises one or more of: financial transaction information, financial account information, or credit reference information.
7. The computer-implemented method of any preceding clause, wherein the first agent is configured to generate the first response based on the user query and augmented data associated with the first context.
8. The computer-implemented method of any preceding clause, comprising: identifying, by one or more of the first agent, the second agent or the answer model, a financial transaction that could be performed; generating, by the answer model, the answer, the answer requesting user permission to process the financial transaction; receiving, by the host computer system, an indication from the user computer system to proceed with the financial transaction; and
   transmitting, by the host computer system, a payment message associated with the financial transaction to a node of an external computer system associated with the user.
9. The computer-implemented method of clause 8, wherein the financial transaction is part of a series of recurring financial transactions, and wherein the method comprises: generating, by the host computer system, a payment schedule for the recurring financial transactions; and transmitting the payment message based at least in part on the payment schedule.
10. The computer-implemented method of any preceding clause, wherein the answer model is configured to: compare the first response and the second response; select one of the first response or the second response based on suitability to the user query; and generate the answer based on the selected one of the first response or the second response.
11. The computer-implemented method of any preceding clause, wherein the answer model is configured to generate the answer based on a combination of the first response and the second response.
12. The computer-implemented method of any preceding clause, comprising: determining, by the answer model and based at least in part on the first response, the second response, and the user query, to request additional information; requesting, by the answer model, the additional information; and re-generating, the first response and the second response based at least in part on the additional information.
13. The computer-implemented method of any preceding clause, wherein the user query is a first user query, and wherein the method comprises: validating, by the router model, a second user query based at least in part on one or more of: format rules or content rules; and rejecting, by the router model, the second user query.
14. The computer-implemented method of any preceding clause, wherein one or more of the router model, the first agent, the second agent, or the answer model comprises a generative machine-learned model.
15. The computer-implemented method of any preceding clause, wherein the first agent or the second agent is associated with one or more of: financial planning, retirement planning, periodic financial planning, savings or investment planning, credit planning, payment scheduling, or output data presentation selection.
16. A computer-implemented method comprising: receiving, at a host computer system, a user query from a user computer system, the user query associated with a financial query; inputting, by the host computer system, the user query into a first model, the first model configured to identify a first agent from a plurality of agents for processing the user query based at least in part on respective profiles of the plurality of agents; providing first information associated with the user query to the first agent; generating, by the first agent, a first response to the user query; and transmitting, to the user computer system, answer information based at least in part on the first response.
17. A system comprising: one or more processors; and memory storing instructions which, when executed by the one or more processors, cause the one or more processors to perform operations comprising: receiving a user query from a user computer system, the user query associated with a request for financial advice from a user; inputting the user query into a router model operated by the system, the router model comprising one or more machine-learned models; determining, by the router model, a first agent and a second agent of a set of agents operated by the system for processing the user query, the set of agents comprising one or more machine-learned models, wherein the router model is configured to determine the first agent and the second agent based at least in part on the user query and on respective profiles of the set of agents, wherein a first profile of the set of agents indicates a first context associated with the first agent, and a second profile of the set of agents indicates a second context associated with the second agent; inputting first information associated with the user query into the first agent to generate a first response to the user query, wherein the first agent is configured based on a first instruction prompt associated with the first context; inputting second information associated with the user query into the second agent to generate a second response to the user query, wherein the second agent is configured based on a second instruction prompt associated with the second context; generating, by an answer model operated by the system, an answer to the user query based on the first response and the second response, the answer comprising one or more of: text, a diagram, or audio output; and transmitting the answer to the user computer system.
18. The system of clause 17, the operations comprising: determining, based at least in part on the user query, to access external information associated with the user; requesting the external information from an external system; receiving the external information from the external system; and one or more of: determining the first agent and the second agent based at least in part on the external information; generating the first response and the second response based at least in part on the external information; or generating the answer to the user query based at least in part on the external information.
19. The system of clause 17 or clause 18, the operations comprising: identifying, based at least in part on the user query, a financial transaction that could be performed; generating, by the answer model, the answer, the answer requesting user permission to process the financial transaction; receiving an indication from the user computer system to proceed with the financial transaction; and transmitting a payment message associated with the financial transaction to a node of an external computer system associated with the user.
20. One or more non-transitory computer-readable media storing instructions which, when executed by a computer, cause the computer to perform operations comprising: receiving a user query from a user computer system, the user query associated with a request for financial advice from a user; inputting the user query into a router model operated by the system, the router model comprising one or more machine-learned models; determining, by the router model, a first agent and a second agent of a set of agents operated by the system for processing the user query, the set of agents comprising one or more machine-learned models, wherein the router model is configured to determine the first agent and the second agent based at least in part on the user query and on respective profiles of the set of agents, wherein a first profile of the set of agents indicates a first context associated with the first agent, and a second profile of the set of agents indicates a second context associated with the second agent; inputting first information associated with the user query into the first agent to generate a first response to the user query, wherein the first agent is configured based on a first instruction prompt associated with the first context; inputting second information associated with the user query into the second agent to generate a second response to the user query, wherein the second agent is configured based on a second instruction prompt associated with the second context; generating, by an answer model operated by the system, an answer to the user query based on the first response and the second response, the answer comprising one or more of: text, a diagram, or audio output; and transmitting the answer to the user computer system.

1. A method for utilizing a plurality of generative artificial intelligence (AI) models for transmitting a response based on a user query, the method comprising:
receiving, by a computing device, from a user device, a user query associated with a request for financial information;
determining a plurality of generative AI models, wherein the plurality of generative AI models comprise a router model, one or more agent models, and an answer model, wherein the router model is configured to select at least one agent model of the one or more agent models based on the user query, wherein the one or more agent models are configured to output one or more responses based on the user query, and wherein the answer model is configured to output a response based on output from the at least one agent model;
determining one or more profiles associated with the one or more agent models, wherein each profile of the one or more profiles comprises an instruction prompt for configuring each agent model of the one or more agent models according to financial context data associated with the corresponding agent model;
selecting, by the router model, based on the user query and the one or more profiles, a first finance agent model of the one or more agent models and a second agent model of the one or more agent models;
extracting, from the user query, based on the financial context data associated with the first agent model and the financial context data associated with the second agent model, first information to be provided to the first agent model and second information to be provided to the second agent model;
generating, by the first agent model, based on the first information, a first response;
generating, by the second agent model, based on the second information, a second response;
generating, by the answer model, based on the first response and the second response, a response associated with the user query, wherein the answer model generates the response according to one or more formats based on the first information and the second information; and
transmitting, to the user device, the response associated with the user query, wherein the user device outputs the response according to the one or more formats.

2. The method of claim 1, further comprising:
determining, by one or more of the plurality of generative AI models, based on the user query to access external information associated with a user;
sending, by the computing device, a request for the external information from an external system;
receiving, from the external system, the external information and
one or more of:
determining, based on the external information, the first agent model and the second agent model;
generating, based on the external information, the first response and the second response; or
generating, based on the external information, the response.

3. The method of claim 2, further comprising:
generating, by the computing device, based on the external information, summarized external information; and one or more of:
determining, based on the summarized external information, the first agent model and the second agent model;
generating, based on the summarized external information, the first response and the second response; or
generating, based on the summarized external information, the response.

4. The method of claim 3, further comprising generating the summarized external information by a non-machine-learned algorithm.

5. The method of claim 2, wherein the user query is received via a user interface displayed by the user device, wherein the method further comprises:
causing, by the computing device, a user interface element to be displayed in the user interface, wherein the user interface element is associated with the external system, and wherein the user interface element is configured to receive credential information from the user for accessing the external information; and
receiving, by the computing device, based on verification of the credential information by the external system, the external information.

6. The method of claim 2, wherein the external information comprises one or more of: financial transaction information, financial account information, or credit reference information.

7. The method of claim 1, wherein the first agent model is configured to generate the first response based on the user query and augmented data associated with the financial context data.

8. The method of claim 1, further comprising:
identifying, by one or more of the first agent model, the second agent model, or the answer model, based on the user query, a financial transaction;
generating, by the answer model, a request for user permission to process the financial transaction;
receiving, by the computing device, from the user device, an indication to proceed with the financial transaction; and
transmitting, by the computing device, to a node of an external computing system associated with a user, a payment message associated with the financial transaction.

9. The method of claim 8, wherein the financial transaction is part of a series of recurring financial transactions, wherein the method further comprises:
generating, by the computing device, a payment schedule for the recurring financial transactions; and
transmitting, based on the payment schedule, the payment message.

10. The method of claim 1, wherein generating, by the answer model, based on the first response and the second response, the response associated with the user query comprises:
comparing, by the answer model, the first response and the second response;
selecting, by the answer model, based on suitability to the user query, one of the first response or the second response; and
generating, by the answer model, based on the selected one of the first response or the second response, the response associated with the user query.

11. The method of claim 1, wherein generating, by the answer model, based on the first response and the second response, the response associated with the user query comprises generating, by the answer model, based on a combination of the first response and the second response, the response associated with the user query.

12. The method of claim 1, further comprising:
sending, by the answer model, based on the first response, the second response, and the user query, a request for additional information; and
re-generating, based on the additional information, the first response and the second response.

13. The method of claim 1, wherein the user query is a first user query, wherein the method further comprises:
validating, by the router model, a second user query based on one or more of: format rules or content rules; and
rejecting, by the router model, the second user query.

14. The method of claim 1, wherein one or more of the router model, the first agent model, the second agent model, or the answer model comprises a generative machine-learned model.

15. The method of claim 1, wherein the first agent model or the second agent model is associated with one or more of:
financial planning, retirement planning, periodic financial planning, savings or investment planning, credit planning, payment scheduling, or output data presentation selection.

16. A method for utilizing a plurality of generative artificial intelligence (AI) models for transmitting a response based on a user query, the method comprising:
receiving, by a computing device, from a user device, a user query associated with a financial query;
determining a plurality of generative AI models, wherein the plurality of generative AI models comprise a router model and one or more agent models, wherein the router model is configured to select at least one agent model of the one or more agent models based on the user query, wherein the one or more agent models are configured to output one or more responses based on the user query;
determining one or more profiles associated with the one or more agent models, wherein each profile of the one or more profiles comprises an instruction prompt for configuring each agent model of the one or more agent models according to financial context data associated with the corresponding agent model;
selecting, by the router model, based on the user query and the one or more profiles, an agent model of the one or more agent models for processing the user query;
generating, by the agent model, based on information associated with the user query, a response to the user query, wherein the response comprises information indicative of one or more formats for outputting answer information based on the information; and
transmitting, to the user device, based on the response, answer information, wherein the user device outputs the answer information according to the one or more formats.

17. An apparatus for utilizing a plurality of generative artificial intelligence (AI) models for transmitting a response based on a user query, the apparatus comprising:
one or more processors; and
a memory storing processor-executable instructions, when executed by the one or more processors, cause the apparatus to:
receive, from a user device, a user query associated with a request for financial information;
determine a plurality of generative AI models, wherein the plurality of generative AI models comprise a router model, one or more agent models, and an answer model, wherein the router model is configured to select at least one agent model of the one or more agent models based on the user query, wherein the one or more agent models are configured to output one or more responses based on the user query, and wherein the answer model is configured to output a response based on output from the at least one agent model;
determine one or more profiles associated with the one or more agent models. wherein each profile of the one or more profiles comprises an instruction prompt for configuring each agent model of the one or more agent models according to financial context data associated with the corresponding agent model;
select, by the router model, based on the user query and the one or more profiles, a first agent model of the one or more agent models and a second agent model the one or more agent models;
extract, from the user query, based on the financial context data associated with the first agent model, and the financial context data associated with the second agent model, first information to be provided to the first agent model and second information to be provided to the second agent model;
generate, by the first agent model, based on the first information, a first response; configured
generate, by the second agent model, based on the second information, a second response;
generate, by the answer model, based on the first response and the second response, a response associated with the user query wherein the answer model generates the response according to one or more formats based on the first information and the second information; and
transmit, to the user device, the response associated with the user query, wherein the user device outputs the response according to the one or more formats.

18. The apparatus of claim 17, wherein the processor-executable instructions, when executed by the one or more processors, further cause the apparatus to:
determine, by one or more of the plurality of generative AI models, based on the user query, to access external information associated with a user;
send a request for the external information from an external system;
receive, from the external system, the external information; and
one or more of:
determine, based on the external information, the first agent model and the second agent model;
generate, based on the external information, the first response and the second response; or
generate, based on the external information, theresponse.

19. The apparatus of claim 17, wherein the processor-executable instructions, when executed by the one or more processors, further cause the apparatus to:
identify, by one or more of the first agent model, the second agent model, or the answer model, based on the user query, a financial transaction
generate, by the answer model, request for user permission to process the financial transaction;
receive, from the user device, an indication to proceed with the financial transaction; and
transmit, to a node of an external computing system associated with a user, a payment message associated with the financial transaction.

20. The apparatus of claim 19, wherein the financial transaction is part of a series of recurring financial transactions, wherein the processor-executable instructions, when executed by the one or more processors, further cause the apparatus to:
generating, by the apparatus, a payment schedule for the recurring financial transactions; and
transmit, based on the payment schedule, the payment message.
